(19) United States
(12) Patent Application Publication
(10) Pub. No.: US 2013/0179230 A1
(43) Pub. Date: Jul. 11, 2013

(54) ORGANIZATIONAL AGILITY IMPROVEMENT AND PRIORITIZATION ACROSS MULTIPLE COMPUTING DOMAINS

(71) Applicants: Samuel Antoun, Brunswick, OH (US); Rick A. Hamilton, II, Charlottesville, VA (US); Kerrie L. Holley, Montara, CA (US); Brian M. O'Connell, RTP, NC (US)

(72) Inventors: Samuel Antoun, Brunswick, OH (US); Rick A. Hamilton, II, Charlottesville, VA (US); Kerrie L. Holley, Montara, CA (US); Brian M. O'Connell, RTP, NC (US)

(73) Assignee: INTERNATIONAL BUSINESS MACHINES CORPORATION, Armonk, NY (US)

(21) Appl. No.: 13/343,806

(22) Filed: Jan. 5, 2012

(51) Int. Cl. G06Q 10/04

(52) U.S. Cl. 705/7.37

(57) ABSTRACT

Embodiments of the present invention provide an approach for determining and/or enhancing an organization's agility across one or more computing domains. Among other things, embodiments of the present invention parse and mine organizational documents for relevant data, calculate and weight business agility scores, determine improvements to optimize domain elements to ensure optimal outcomes for customers, prioritize improvements, and/or provide organization agility information for transfer to consultants or the like. It is understood that these functions may be used independently or in conjunction with each other depending on the scope of improvement desired for a particular organization.

### TECHNICAL FIELD

Embodiments of the present invention relate to organizational agility. Specifically, embodiments of the present invention relate to computer-implemented organizational agility improvement and prioritization across one or more computing domains.

### BACKGROUND

Organizational agility is the collective measure of an organization's ability to achieve its desired outcomes, be predictive, flexible, and responsive, and launch new initiatives. Furthermore, organizational agility encompasses an ability of an organization to adapt rapidly, effectively, and cost efficiently in response to changes in the economic environment. Still yet, organizational agility gauges an ability of the organization to quickly adjust to, and take advantage of, emerging opportunities.

An organization that is considered to be agile strives to make change a routine part of organizational life in order to reduce or eliminate the organizational issues that may slow the progression of attempts to adapt to new markets and environments. Because change may be perpetual, an agile organization is able to quickly adjust to, and take advantage of, emerging opportunities. An organization that is agile may be viewed as an integral component of a larger system whose activities produce a ripple effect of change both within the enterprise itself and the broader system. Challenges may exist, however, in accurately and efficiently measuring an organization's agility. Without such a measure, it may be difficult to determine where improvement is needed.

### SUMMARY

Embodiments of the present invention provide an approach for determining and/or enhancing an organization's agility across one or more computing domains. Among other things, embodiments of the present invention parse and mine organizational documents for relevant data, calculate and weight business agility scores, determine improvements to optimize domain elements to ensure optimal outcomes for customers, prioritize improvements, and/or provide organization agility information for transfer to consultants or the like. It is understood that these functions may be used independently or in conjunction with each other depending on the scope of improvement desired for a particular organization.

A first aspect of the present invention provides a computer-implemented method for improving organizational agility of an organization across multiple computing domains, comprising: receiving a set of organizational documents in a computer memory medium, the organizational documents being associated with the organization; analyzing the set of organizational documents for a set of keywords that is indicative of the organizational agility of the organization; calculating a set of agility scores based on the analyzing using a set of agility computation rules; weighting the set of agility scores based on at least one of the following: a set of industry vertical factors associated with the organization, a size of the organization, a geographic region associated with the organization, and a competitive position associated with the organization; determining a set of improvements to the organization based on the weighted set of agility scores; and prioritizing the set of improvements based on at least one of the following: a time to implement the set of improvements, or a level of need of the set of improvements as indicated by the weighted set of agility scores.

A second aspect of the present invention provides a system for improving organizational agility of an organization across multiple computing domains, comprising: a memory medium comprising instructions; a bus coupled to the memory medium; and a processor coupled to the bus that when executing the instructions causes the system to: receive a set of organizational documents in a computer memory medium, the organizational documents being associated with the organization; analyze the set of organizational documents for a set of keywords that is indicative of the organizational agility of the organization;

calculate a set of agility scores based on the analysis using a set of agility computation rules; weight the set of agility scores based on at least one of the following: a set of industry vertical factors associated with the organization, a size of the organization, a geographic region associated with the organization, and a competitive position associated with the organization; determine a set of improvements to the organization based on the weighted set of agility scores; and prioritize the set of improvements based on at least one of the following: a time to implement the set of improvements, or a level of need of the set of improvements as indicated by the weighted set of agility scores.

A third aspect of the present invention provides a computer program product for improving organizational agility of an organization across multiple computing domains, the computer program product comprising a computer readable storage media, and program instructions stored on the computer readable storage media, to: receive a set of organizational documents in a computer memory medium, the organizational documents being associated with the organization; analyze the set of organizational documents for a set of keywords that is indicative of the organizational agility of the organization; calculate a set of agility scores based on the analysis using a set of agility computation rules; weight the set of agility scores based on at least one of the following: a set of industry vertical factors associated with the organization, a size of the organization, a geographic region associated with the organization, and a competitive position associated with the organization; determine a set of improvements to the organization based on the weighted set of agility scores; and prioritize the set of improvements based on at least one of the following: a time to implement the set of improvements, or a level of need of the set of improvements as indicated by the weighted set of agility scores.

A fourth aspect of the present invention provides a method for deploying a system for improving organizational agility of an organization across multiple computing domains, comprising: providing a computer infrastructure being operable to: receive a set of organizational documents in a computer memory medium, the organizational documents being associated with the organization; analyze the set of organizational documents for a set of keywords that is indicative of the organizational agility of the organization; calculate a set of agility scores based on the analysis using a set of agility computation rules; weight the set of agility scores based on at least one of the following: a set of industry vertical factors associated with the organization, a size of the organization, a geographic region associated with the organization, and a competitive position associated with the organization; determine a set of improvements to the organization based on the weighted set of agility scores; and prioritize the set of improvements based on at least one of the following: a time to implement the set of improvements, or a level of need of the set of improvements as indicated by the weighted set of agility scores.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a system diagram according to an embodiment of the present invention.

FIG. 3 depicts a diagram of the organization agility determination engine/program according to embodiment of the present invention.

FIG. 4 depicts a method flow diagram according to an embodiment of the present invention.

FIG. 5 depicts another method flow diagram according to an embodiment of the present invention.

FIG. 6 depicts another method flow diagram according to an embodiment of the present invention.

FIG. 7 depicts another method flow diagram according to an embodiment of the present invention.

FIG. 8 depicts another method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

In general, embodiments of the present invention provide an approach for determining and/or enhancing an organization's agility across one or more computing domains. Among other things, embodiments of the present invention parse and mine organizational documents for relevant data, calculate and weight business agility scores, determine improvements to optimize domain elements to ensure optimal outcomes for customers, prioritize improvements, and/or provide organization agility information for transfer to consultants or the like. It is understood that these functions may be used independently or in conjunction with each other depending on the scope of improvement desired for a particular organization.

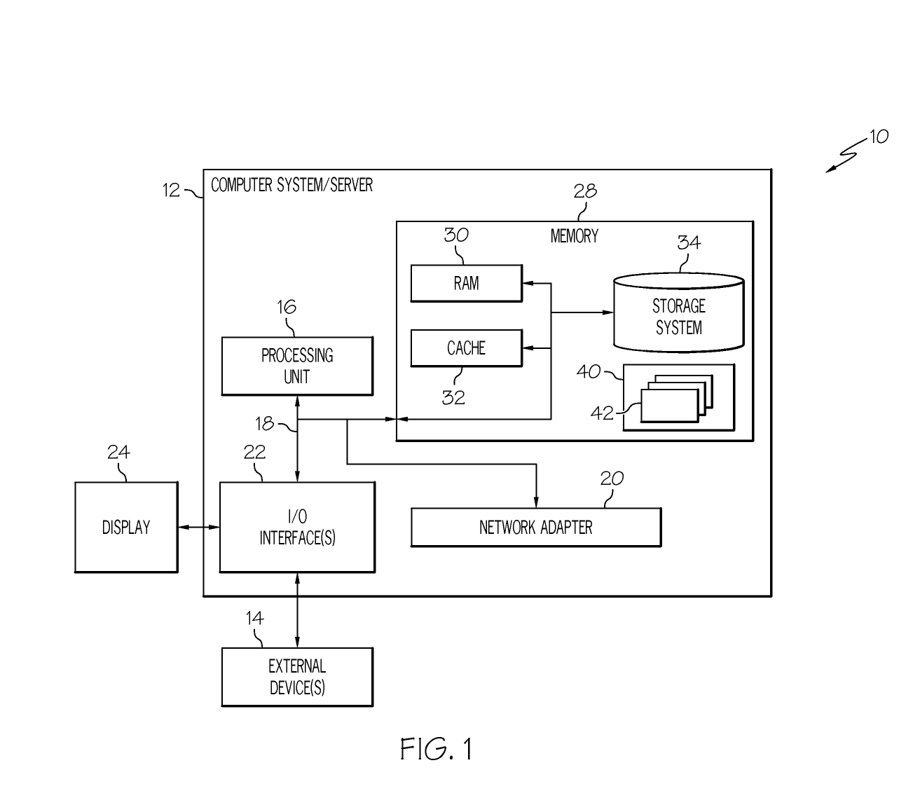

Referring now to FIG. 1, a schematic of an example of a computing node is shown. Computing node 10 is only one example of a suitable structure computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable structure for use with computer system/server 12 include, but are not limited to, personal computer systems, server computer systems, thin clients, thick clients, hand-held or laptop devices, mobile devices, global positioning systems (GPS), GPS-enable devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable structure instructions, such as program modules, being executed by a computer system. Generally, program modules may include routines, programs, objects, components, logic, data structures, and so on, which perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable structure combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable structure combination of the foregoing.

Organization agility determination program/utility 40, having a set (at least one) of program modules 42, may be stored in memory 28 by way of example, and not limitation, as well as an operating system, one or more application programs, other program modules, and program data. In general, organization agility determination program 40 performs the function of the present invention as described herein.

Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

As indicated above, embodiments of the present invention provide an approach for determining the business agility of an organization that may span multiple computing domains. One type of enterprise architecture that supports agility is a no-hierarchical organization without a single point of control where individuals may function relatively autonomously. Roles and responsibilities may not be predetermined, but, rather, may emerge from individuals' self-organizing activities and may be constantly in flux. Similarly, projects may be generated everywhere in the enterprise, sometimes even from outside affiliates. Along these lines, key decisions may be made collaboratively or on the spot. Because of this, knowledge, power, and intelligence may be spread through the enterprise, making it uniquely capable of quickly recovering and adapting to the loss of any key enterprise component.

One focus of agility determination methods is to address the issues of complexity, uncertainty, and dynamic goals by making planning and execution of workloads in parallel rather than in sequence. Such workload execution may assist in eliminating unnecessary planning activities and the resulting unnecessary work. Agility methods integrate planning with execution allowing an organization to “search” for an optimal ordering of work tasks and to adjust to changing requirements. Some causes of disarray on a project include incomplete understanding of project components, incomplete understanding of component interactions, and changing requirements. Moreover, requirements for a project may change over time as a greater understanding of the project components unfolds. Requirements may also change due to changing needs and wants of the parties involved. An “agile” approach or organizational philosophy allows a team or organization to implement successful projects quickly by only focusing on a small set of details in any change iteration. This is in contrast to non-agile approaches in which all the details necessary for completion may be given equal priority.

Along these lines, the embodiments of the present invention provide an approach to automatically derive a business/organizational agility score of an organization across multiple computing domains. Specifically, the approach described herein provides a system to obtain corporate documents (e.g., electronic), analyze those documents, and calculate a business agility score for the organization. Document consumption may automatically detect or highlight governance levels and/or organizational culture. The documents may also be used to fully calculate the score or assist a consultant by providing a possible range of scores, thereby reducing human intervention times. Furthermore, the approach described herein provides algorithmic weighting based on standards for multiple areas such as (among others): industry vertical factors, organizational size, geographic region, and/or competitive positioning associated with an organization. Use of such automated tuning allows business agility scores to accurately reflect the priorities and environments of a company within a particular business ecosystem.

Still yet, the approach described herein may utilize automatic document discovery methods and analysis to select documents of interest and automatically transfer and highlight said documents to agility consultants. This method may automatically transfer white papers, action plans, business plans, etc., to consultants. In one embodiment, sensitive and confidential information may automatically be detected and transferred to the corporation's legal department for review prior to release. The automatic document detection and transfer of pertinent information may assist consultants in providing the most accurate recommendations without requiring consultants to read all corporate documentation.

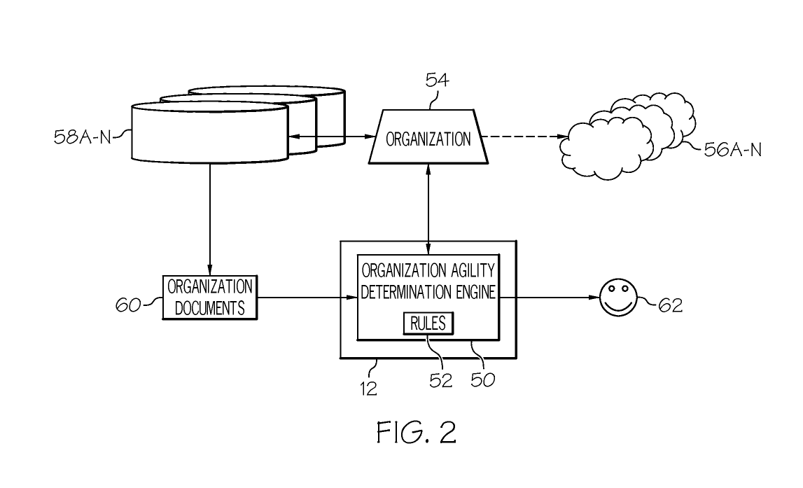

Referring now to FIG. 2, a system diagram capable of implementing the functionality discussed herein according to an embodiment of the present invention is shown. It is understood that the teachings recited herein may be practiced within any type of networked computing environment (e.g., a cloud computing environment, or a grid computing environment). A stand-alone computer system/server 12 is shown in FIGS. 1 and 2 for illustrative purposes only. In the event the teachings recited herein are practiced in a networked computing environment, each client need not have a business agility determination engine (engine 50). Rather, engine 50 could be loaded on a server or server-capable device that communicates (e.g., wirelessly) with the clients to provide device protection therefor.

Regardless, as depicted, engine 50 is shown within computer system/server 12. In general, engine 50 can be implemented as organization agility determination program/utility 40 on computer system 12 of FIG. 1 and can enable the functions recited herein. As further shown, engine 50 (in one embodiment) comprises a rules and/or computational engine that processes a set (at least one) of rules 52 and/or provides confidence-based computing resource allocation hereunder.

Along these lines, engine 50 may perform multiple functions similar to a general-purpose computer. Specifically, among other functions, engine 50 may (among other things): receive a set of organizational documents 60 (e.g., electronically from one or more computer storage devices 58A-N) associated with an organization 54 (e.g., across one or more computing domains 56A-N) in a computer memory medium; analyze the set of organizational documents 50 for a set of keywords that is indicative of the organizational agility of the organization 54; calculate a set of agility scores based on the analyzing using a set of agility computation rules; weight the set of agility scores based on at least one of the following: a set of industry vertical factors associated with the organization 54, a size of the organization 54, a geographic region associated with the organization 54, and a competitive position associated with the organization 54; provide output (e.g., to a user/consultant 62) based on the calculating and weighting; determine a governance of the organization 54 based on the set of keywords; determine a management structure of the organization 54 based on the set of keywords; and/or identify one or more areas where information associated with the organization agility was lacking.

### Illustrative Implementation

This section describes one illustrative approach for implementing the teachings and/or functions recited herein. It is understood that this is one possible way of implementing the embodiments of the present invention and that other alternatives could exist.

### I. Automated Business Agility Calculation Method:

This method may automatically derives a business agility score of an organization across multiple computing domains. Details are disclosed to obtain corporate documents, analyze those documents, and calculate, in part or in whole, the business agility score for the organization. Document analysis may automatically detect or highlight governance levels and organizational culture. The obtained documents may be used to fully calculate the score or assist a consultant by providing a possible range of scores, thereby reducing human intervention times.

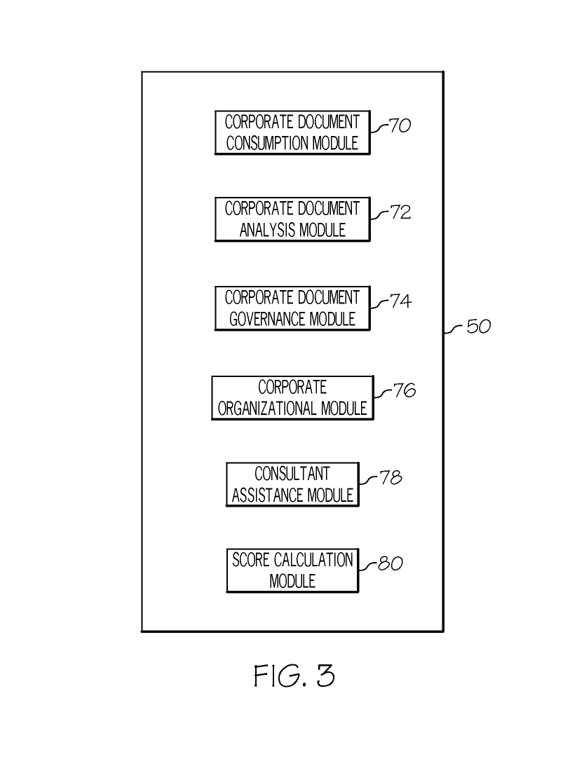

Referring now to FIG. 3 an illustrative diagram of engine 50 is shown. The modules shown in FIG. 3 generally outline logical functions contained within a computer-assisted logical implementation of the embodiments of the present invention. Such modules may be broken out into separate computer program functions, or they may be contained within a single (or smaller number of) computer program(s).

Corporate Document Consumption Module 70: This module acquires corporate documents for analysis. Several embodiments for consumption/location are possible. In one embodiment, a web crawler is used to fetch documents from the corporate intranet and place them in a relational datastore. In an alternate embodiment, the consultant selects a subset of documents for consumption and provides them to the consumption module through a computerized, potentially web-enabled, document repository interface. In yet another embodiment, the organization's email documents are provided to this module for consumption. In the preferred email consumption embodiment, a specialized program connects to the corporate mail servers and extracts relevant historical correspondence. If the email server does not support historical document retention, a different method may be used in which a program is installed atop the mail server to record correspondence for future analysis. These documents may be automatically limited to include only those in senior or upper management, in such situations where this limitation may yield better results. This module, based on its keyword analysis, may assign positive scores to beneficial practices and negative scores to detrimental practices. Note that such keyword analysis and score assignment may occur either in the consumption module or in the analysis module below.

Corporate Document Analysis Module 72: This module calculates the current business agility for an organization. Documents acquired by the consumer module described above are analyzed for a set of keywords and keyword counts. These keywords are then fed into known rules-based engines to ascertain a likely business agility score. Additionally, text analytics engines such as that provided by IBM® Corporate Brand and Reputation Analysis (COBRA) (IBM and related terms are trademarks of International Business Machines Corp. in the United States and/or other countries) may be used to discern trends across disparate documents. This trend analysis is used to assist in calculation of the agility score. COBRA leverages advanced and deep text and data analytics techniques to mine wide range of social media content, such as blogs, news, forums, and corporate internal information to derive customer and enterprise insights, such as brand and reputation insights, risk and compliance monitoring, market and competitive insights.

Corporate Document Governance Module 74: A special analysis may be used to calculate governance within an organization. For example, specific keywords may be searched through the consumed documents to determine the amount of governance within an organization. Additionally, this module may automatically ingest employee titles through either email scans, document scans, or access to the employee directory. Employee title analysis may be used to discern the amount of governance in an organization.

Corporate Organizational Module 76: This module ingests organization information to determine how “flat” an organization is. One part of being agile may include having flattened management structure. This module may ingest relevant information from structured corporate sources (e.g., published organizational charts or from unstructured sources, email scans, looking for words such as “manager” to infer such a structure, etc.). In one embodiment, this module may link to a corporate directory from which it may calculate the organizational structure and assign a score based on the structure.

Consultant Assistance Module 78: This optional module may be invoked after the previous modules and informs the consultant as to which areas it was unable to obtain information. At that point, the consultant may conduct focused interviews for the areas of need. Once those interviews are done, the consultant may generate a score for the needed areas as is presently known. Upon completion of the calculation, the consultant will provide scores to the score calculation module.

Score Calculation Module 80: This module calculates the overall agility score for an organization based on the analysis provided by the previous modules and the input from the consultant.

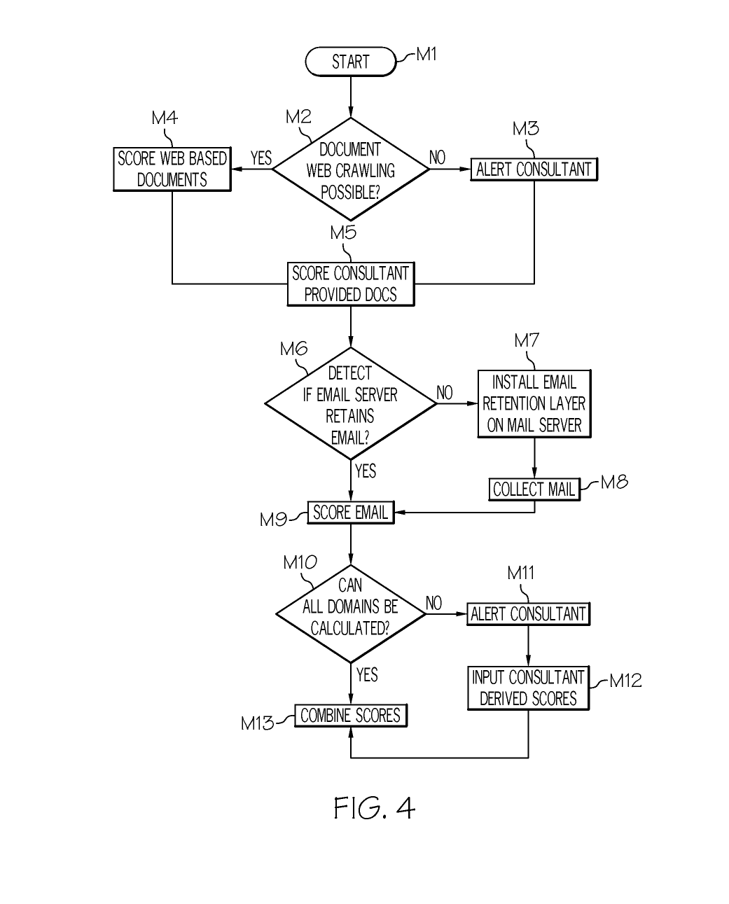

Referring now to FIG. 4, a flow diagram illustrating the automated business agility calculation method discussed above is shown. As depicted, the process is started in step M1. In step M2, it is determined whether document web crawling is possible (e.g., by corporate document consumption module 70). If not, a consultant can be alerted in step M3. If so, web-based documents are scored in step M4 (e.g., by corporate document analysis module 72). In either event, consultant provided documents can be scored in step M5, and it is determined in step M6 if the applicable email server retains emails (e.g., by corporate document governance module 74). If not, an email retention layer is installed in step M7, and email is collected in step M8. Then, the retained email can be scored in step M9. In step M10, it is determined whether all domains can be calculated. If not, the consultant is alerted in step M11, and input is received from the consultant in the form of derived scores in step M12. Once all domains can be calculated and/or consultant scores are received, they will be combined in step M13 (e.g., by score calculation module 80).

### II. Automatic Weighting of Domains and Domain Elements to Optimize Client/Customer Organizational Environment:

This method automatically weights (i.e., tunes business agility domain elements to optimize outcomes for specific clients/customers). This method provides algorithmic weighting based on standards for four distinct areas: industry vertical factors, organizational size, geographic region, and competitive positioning. Depending on embodiment, any or all of these four areas may be used to optimize weighting. Use of such automated tuning allows business agility scores to accurately reflect the priorities and environments of a company within a particular business ecosystem.

Industry verticals factors: A vertical market is a group of similar businesses and customers that engage in trade based on specific and specialized needs. Based on known information about popular industry verticals, this invention may weight specific agility enhancements above others to provide a competitive advantage.

Organizational size: The size of a specific organization changes the weighting of various improvement areas for business agility. Large organizations of common size may generally need to focus improvements in one area, while smaller corporations may benefit by focusing on other improvement realms. Based on organization size, this invention may weight various factors differently.

Geographic region: The geographic region or regions of a corporation may modify the weightings for various improvement areas. The geographic region may be automatically calculated by the document ingestion modules described above. For example, different agility areas may be of different values depending on the region. Additionally, if some improvements require government compliance/oversight, improvement order may be modified, depending on geography,

Competitive position: The organization's competitive position may be used to modify the weighting for specific domain elements. For example, if an organization has a competitive advantage in one product or services area, the weighting for that area's improvement need may be modified vis-à-vis a different domain in which they are at a disadvantage compared to competitors.

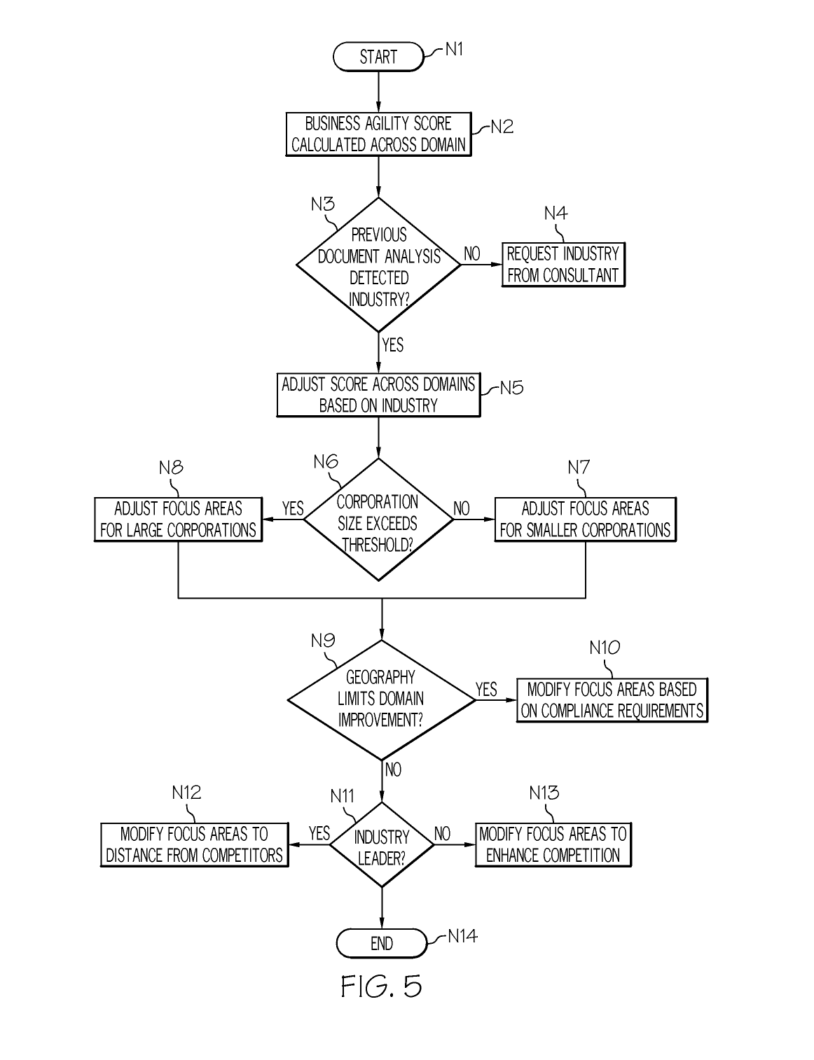

Referring now to FIG. 5, a flow diagram illustrating the automatic weighting of domains and domain elements to optimize clients/customers is shown. The process is started in step N1 and in step N2, a business/organizational agility score is determined/calculated. In step N3, it is determined whether a previous document analysis detected an applicable business industry. If not, identification of the industry is requested from a consultant in step N4. In step N5, scores are adjusted across the domains based on the industry. In step N6, it is determined whether a size of the corporate exceeds a predetermined threshold. If so, focus areas are adjusted to smaller companies in step N7. If not, focus areas are adjusted for large corporations in step N8. In either event, it is thereafter determined whether geography limits domain improvement in step N9. If so, focus areas are modified based on applicable compliance requirements in step N10. If not, it is determined whether the organization is deemed to be an industry leader in step N11 (e.g., based on independent business rankings). If so, focus areas can be modified to enhance competition in step N12. If so, focus areas can be enhanced to distance organization from competitors in step N13. In either case, the process can then be ended in step N14.

### III. Domain Area Prioritization:

This method automatically prioritizes improvements for an organization. Prioritization score may encompass one or both of multiple distinct features (e.g., time to implement, and/or most detrimental to agility/a level of need of an improvement). For example, through historical or other empirical analysis, the time to implement each recommendation may be calculated. Therefore, each recommendation may include an implementation window. In another aspect of this invention, document analysis is performed to determine which elements are most detrimental to agility. This may include automatic email and instant messaging ingestion to determine which aspects cause the most complaints. The elements with higher risks, potentially automatically weighted by employee hierarchy, may be weighted higher than other elements for improvement. The elements with the least time to implement and higher detriment may be selected for improvement before those with lower combined scores.

Implementation Estimation: In this method, historical analysis is used to determine an estimate for the length of time that any given agility improvement implementation may take (e.g., using historical data from storage devices 58A-N of FIG. 2). This method may store the implementation time for each improvement area. Over time, that data set is used to estimate implementation times of similar organizations. In addition to historical analysis methods, several data points describing the current customer may be used to automatically calculate the estimation. The first such data point may be the previously calculated score for agility within the current domain. For example, if a customer has a low agility score for a domain, it may take longer to implement improvements than if their agility score was at the median for that domain. Another data point may be the size of the organization. Specifically, it may be common for larger organizations to take longer to modify their structures and methods. As such, the size of the corporation may affect the implementation time. The impact may be linear, stepwise, or follow other known mathematical models. One additional exemplary element may be the available funds within the organization to implement change. Some implementations may be costly, and, depending on the funds available, the implementation may be faster or slower than previous implementations.

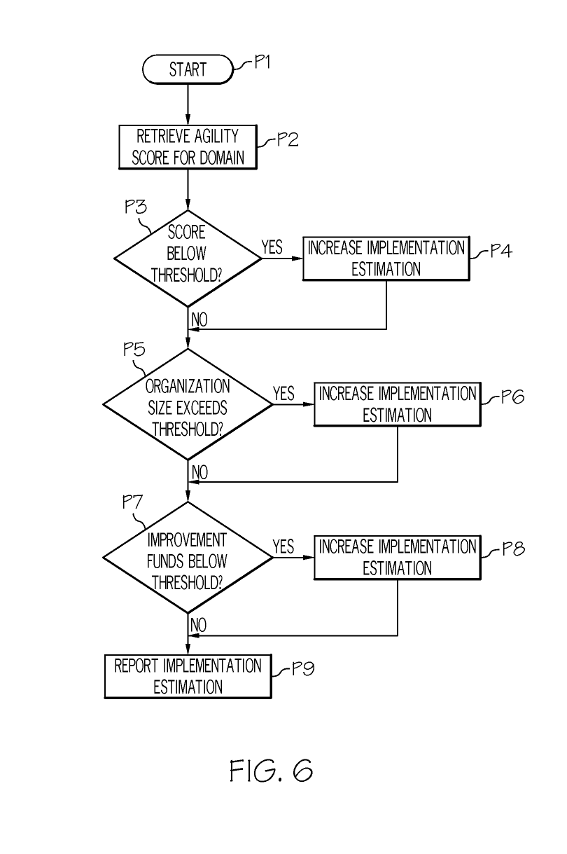

Referring now to FIG. 6, a flow diagram illustrating the concepts of prioritizing improvements described in this section is shown. As depicted, the process is started in step P1 and in step P2, a relative agility score is obtained for each domain. In step P3, it is determined whether the score is below a predetermined threshold. If not, the process flows to step P5. If so, the implementation estimation is increased in step P4 before the process flows to step P5 where it is determined whether the organization exceeds a predetermined size threshold. If not, the process flows directly to step P7. If so, the implementation estimation is increased in step P6 before it is determined in step P7 whether improvements funds are below a funding threshold. If no, the process flows directly to step P9. If so, the implementation estimation is increased in step P8, before the total implementation estimation is reported in step P9.

### IV. Agility Detriment Calculation

This method uses several functions to determine how detrimental a particular domain score is to the organization's agility. These functions include document ingestion and analysis, email discovery and analysis, and employment hierarchy weighting. Details for each function are provided below.

Document Ingestion: The document ingestion function acquires documents for detriment analysis. In one embodiment, a web crawler may be used to obtain documents from the corporate intranet and place them in a relational data store. In an alternate embodiment, a consultant may select a subset of documents for consumption and provide the subset to the corporate document consumption module (70 of FIG. 3) through a computerized, potentially web-enabled, document repository interface. The corporate document analysis module (72 of FIG. 3) may first scan the documents using keyword analysis to determine which documents are describing business hurdlers or “pain points”. Upon selecting that set of documents, the system may then scan the documents using technologies such as IBM COBRA or other textual analysis software to thematically separate documents by domain applicability. Regardless, upon completion, each domain area may be assigned a detriment score.

Email Discovery: In an email discovery embodiment, a specialized program may connect to corporate mail servers and may extract relevant historical correspondence. If the email server does not support historical document retention, a different method may be used in which a program is installed atop the mail server to record correspondence for future analysis. The corporate document analysis module 72 may first scan the emails using keyword analysis to determine which emails are describing business hurdlers or “pain points”. Upon selecting that set of emails, the system may next scan the documents using technologies such as IBM COBRA or other textual analysis software to thematically separate emails by domain applicability. Upon completion, each domain area may be assigned a detriment score. The scores from a document ingestion module and an email discovery module (collectively shown as corporate document consumption module 70 in FIG. 3) are combined to determine the overall detriment score. It should be noted that in most embodiments, the email score may be given a higher weight, as it is more common for people to describe business complaints in emails rather than formal documents.

Employment Hierarchy Weighting: This method performs post processing and weight adjustments on the document ingestion and email discovery modules. An employment hierarchy may be discovered using manual input, email chain forwarding analysis, or directory integration. This method then modifies the weighting for individual documents based on the employee's position in the organization's hierarchy.

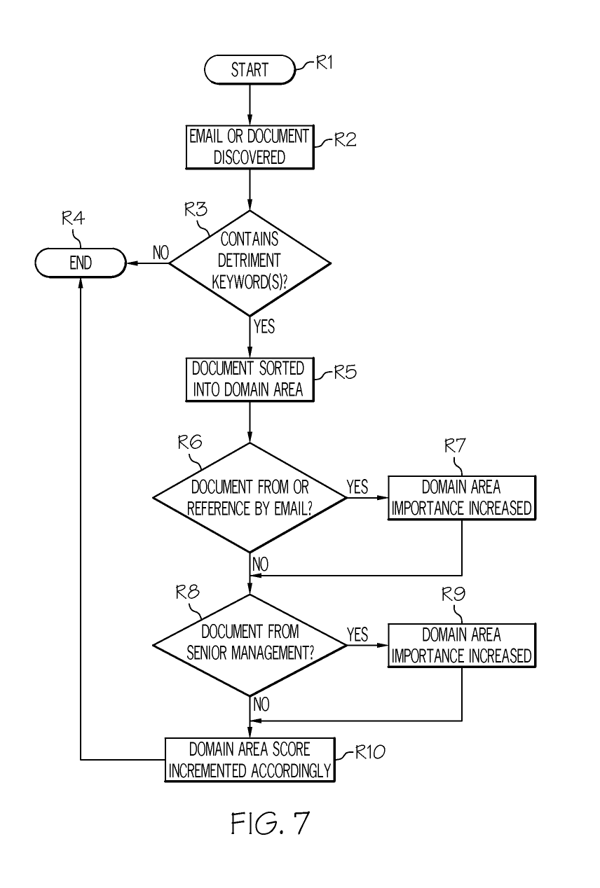

Referring now to FIG. 7, a flow diagram illustrating the concepts described in this section for calculating agility detriment is shown. The process is started in step R1 and in step R2, email or other corporate document(s) are discovered. In step R3, it is determined whether the discovered document(s) contain certain keywords. If not, the process is ended in step R4. If so, the documents are sorted by organizational domain area in step R5, and in step R6, it is determined whether the documents are from, or referenced by another email. If not, the process flows directly to step R8. If so, the corresponding domain area's importance level is increased in step R7 before it is determined in step R8 whether the documents are from senior management within the organization. If not, the process flows directly to step R10. If so, the corresponding domain area's importance level is increased in step R9 before the total domain score is calculated in step R10 before the process ends in step R4.

### V. Element Selection

This method combines the results from the implementation estimation module and the agility detriment output to rank which domain elements should be improved first. This ranking may be adjusted to meet customer expectations by the consultant based on additional material discovered during interviews.

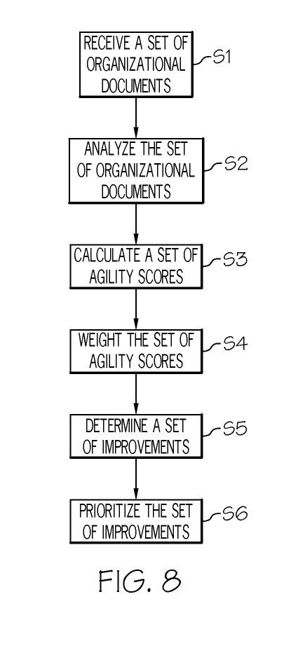

Referring now to FIG. 8, a method flow diagram according to an embodiment of the present invention is shown. In step S1, a set of organizational documents associated with an organization is received in a computer memory medium. In step S2, the set of organizational documents is analyzed for a set of keywords that is indicative of the business agility of the organization. In step S3, a set of agility scores is calculated based on the analyzing using a set of agility computation rules. In step S4, the set of agility scores is weighted based on at least one of the following: a set of industry vertical factors associated with the organization, a size of the organization, a geographic region associated with the organization, and a competitive position associated with the organization. In step S5, a set of improvements to the organization is determined based on the weighted set of scores. In step S6, the set of improvements are prioritized (e.g., based on an implementation time or a level of need thereof).

### Illustrative Pseudo Code

This section comprises illustrative pseudo code that performs some of the analysis functions set forth above (e.g., similar to COBRA).

/* This java class implements a table, where each row of the table

represents a positive antecedent of the generated rule

```
*/
  public class RuleTable extends AbstractInfo implements TableInfo
  { public
```

TextClustering tc = null; // contains the feature space for the

document corpus and two categories “recent” and “Other”.

RuleSet rs = null;
HashMap featMap = null;
int fSize = 200; // number of features to use during rule generation.

//The creation method takes in a feature space and data partition
(TextClustering) and builds a rule based classifier based on this
information (rule induction)

public RuleTable(TextClustering t) {

tc = t;
TMCLRuleBased trb = new TMCLRuleBased (tc,

tc.attribNames.length, tc.ndata, tc.nclusters); //rule induction engine

selectFeatures( );
registerData(trb);
System.out.printIn(“About to build classifier”);
trb.buildClassifier( ); //perform rule induction
rs = com.ibm.cv.text.metric.UtilM.getRuleSet(trb);
try { // remove any rules that are not generated for the “recent”
category
for (int i=rs.size( )−1; i>=0; i−−) {

```
  Rule r = rs.getRule(i);
  if (r.getCategory( ).equals(“recent”)) continue;
  rs.removeRule(i);
```

}
} catch (Exception e) {e.printStackTrace( );}

}

// Select the best features to use for rule induction

protected void selectFeatures( )

{

FeatureSelection fs = new FeatureSelection(tc);
featMap = new HashMap( );
featMap = fs.selectFeatures(fSize, featMap);
fSize = (short) featMap.size( );
System.out.printIn(“fSize = ” + fSize);

}

// Register the data to use for rule induction

protected void registerData(TMCLRuleBased trb)
{

short count = 0;
if (tc.ndata<10000000) { // if data set is too large, then sample.
for (int i=0; i<tc.ndata; i++)

{

trb.registerID(i);
//trb.registerClass(count, (short)
tc.smembership[i]);

}

}
else {

```
  float percentage = 10000.0F/tc.ndata;
  int pos =
  com.ibm.cv.Util.findPosition(“recent”,tc.clusterNames);
  for (int i=0; i<tc.ndata; i++) {
```

if (tc.smembership[i]==pos) trb.registerID(i);
if (Math.random( )<percentage) trb.registerID(i);

}

}
trb.finishRegistration( );

}
// The remaining methods are access methods for information contained
in the rule table.

public int getRowCount( ) {

return rs.size( );

}
public int getColumnCount( ) {

```
return 3;
}
public String getColumnName(int columnIndex) {
  switch (columnIndex) {
  case 0:
```

return “Category”;

case 1:

return “Rule”;

case 2:

return “Confidence”;

}
return null;

}
public Class getColumnClass(int columnIndex) {

return String.class;

}

// Returns the rule antecedent (and other information) for each relevant
rule.

public Object getValueAt(int rowIndex,

int columnIndex) {

```
  Rule r = null;
  try {
```

```
  r = rs.getRule(rowIndex);
  switch (columnIndex) {
  case 0:
```

return r.getCategory( );

case 1:

String rc =“”;
for (int i=0; i<r.getAntecedentSize( );i++) {

```
  if (i!=0) rc = rc+“ & ”;
  rc= rc+ r.getAntecedent(i).asString( );
}
return rc;
```

case 2:

return new Float(r.getConfidence( ));

}

} catch (Exception e) {

e.printStackTrace( );
return null;

}
return null;

}

While shown and described herein as an organization agility improvement system, it is understood that the invention further provides various alternative embodiments. For example, in one embodiment, the invention provides a computer-readable/useable medium that includes computer program code to enable a computer infrastructure to provide organization agility improvement functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable structure storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide organization agility improvement functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for organization agility improvement. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable structure for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

1. A computer-implemented method for improving organizational agility of an organization across multiple computing domains, comprising:
receiving a set of organizational documents in a computer memory medium, the organizational documents being associated with the organization;
analyzing the set of organizational documents for a set of keywords that is indicative of the organizational agility of the organization;
detecting an identifier of an employee within at least one of the set of organizational documents;
assigning an importance level to each of the at least one of the set of organizational documents based on a Position of the employee in an employment hierarchy of the organization;
calculating a set of agility scores based on the analyzing and importance level using a set of agility computation rules;
weighting the set of agility scores based on at least one of the following: a set of industry vertical factors associated with the organization, a size of the organization, a geographic region associated with the organization, and a competitive position associated with the organization;
determining a set of improvements to the organization based on the weighted set of agility scores; and
prioritizing the set of improvements based on a historical analysis of time to implement the set of improvements by organizations similar to the organization.

2. (canceled)

3. The computer-implemented method of claim 2, the analyzing further comprising determining a management structure of the organization based on the set of keywords, the set of agility scores being further based on the management structure.

4. The computer-implemented method of claim 1, further comprising identifying one or more areas where information associated with the organization agility was lacking.

5. The computer-implemented method of claim 1, the set of industry vertical factors pertaining to a set of business needs of the organization.

6. The computer-implemented method of claim 1, the level of need corresponding to a detrimental effect on the organization of one or more factors addressed by the set of improvements.

7. The computer implemented method of claim 1, the weighting comprising weighting the set of agility scores based on a position in a hierarchy of the organization of one or more individuals associated with the set of organizational documents.

8. A system for improving organizational agility of an organization across multiple computing domains, comprising:
a memory medium comprising instructions;
a bus coupled to the memory medium; and
a processor coupled to the bus that when executing the instructions causes the system to:
receive a set of organizational documents in a computer memory medium, the organizational documents being associated with the organization;
analyze the set of organizational documents for a set of keywords that is indicative of the organizational agility of the organization;
detect an identifier of an employee within at least one of the set of organization documents;
assign an importance level to each of the at least one of the set of organizational documents based on a position of the employee in an employment hierarchy of the organization;
calculate a set of agility scores based on the analysis and the importance level using a set of agility computation rules;
weight the set of agility scores based on at least one of the following: a set of industry vertical factors associated with the organization, a size of the organization, a geographic region associated with the organization, and a competitive position associated with the organization;
determine a set of improvements to the organization based on the weighted set of agility scores; and
prioritize the set of improvements based on a time to implement the set of improvements, the time to implement being calculated based on at least one of the agility score, a size of the organization, and available funds within the organization to implement the set of improvements.

9. (canceled)

10. The system of claim 9, the memory medium further comprising instructions for causing the system to determine a management structure of the organization based on the set of keywords, the set of agility scores being further based on the management structure.

11. The system of claim 8, the memory medium further comprising instructions for causing the system to identify one or more areas where information associated with the organization agility was lacking.

12. The system of claim 8, the set of industry vertical factors pertaining to a set of business needs of the organization.

13. The system of claim 8, the level of need corresponding to a detrimental effect on the organization of one or more factors addressed by the set of improvements.

14. The system of claim 8, the memory medium further comprising instructions for causing the system to weight the set of agility scores based on a position in a hierarchy of the organization of one or more individuals associated with the set of organizational documents.

15. A computer program product for improving organizational agility of an organization across multiple computing domains, the computer program product comprising a computer readable storage media, and program instructions stored on the computer readable storage media, to:
receive a set of organizational documents in a computer memory medium, the organizational documents being associated with the organization;
analyze the set of organizational documents for a set of keywords that is indicative of the organizational agility of the organization;
detecting an identifier of an employee within at least one of the set of organization documents;
assign an importance level to each of the at least one of the set of organizational documents based on a Position of the employee in an employment hierarchy of the organization;
calculate a set of agility scores based on the analysis and the importance level using a set of agility computation rules;
weight the set of agility scores based on at least one of the following: a set of industry vertical factors associated with the organization, a size of the organization, a geographic region associated with the organization, and a competitive position associated with the organization;
determine a set of improvements to the organization based on the weighted set of agility scores; and
prioritize the set of improvements based on a time to implement the set of improvements, the time to implement being based on at least one of a historical analysis, the agility score, a size of the organization, and available funds within the organization to implement the set of improvements.

16. (canceled)

17. The computer program product of claim 16, the computer readable storage media further comprising instructions to determine a management structure of the organization based on the set of keywords, the set of agility scores being further based on the management structure.

18. The computer program product of claim 15, the computer readable storage media further comprising instructions to identify one or more areas where information associated with the organization agility was lacking.

19. The computer program product of claim 15, the set of industry vertical factors pertaining to a set of business needs of the organization.

20. The computer program product of claim 15, the level of need corresponding to a detrimental effect on the organization of one or more factors addressed by the set of improvements.

21. The computer program product of claim 15, the computer readable storage media further comprising instructions to weight the set of agility scores based on a position in a hierarchy of the organization of one or more individuals associated with the set of organizational documents.

22. A method for deploying a system for improving organizational agility of an organization across multiple computing domains, comprising:
providing a computer infrastructure being operable to:
receive a set of organizational documents in a computer memory medium, the organizational documents being associated with the organization;
analyze the set of organizational documents for a set of keywords that is indicative of the organizational agility of the organization;
detect an identifier of an employee within at least one of the set of organization documents;
assign an importance level to each of the at least one of the set of organizational documents based on a Position of the employee in an employment hierarchy of the organization;
calculate a set of agility scores based on the analysis and the importance level using a set of agility computation rules;
weight the set of agility scores based on at least one of the following: a set of industry vertical factors associated with the organization, a size of the organization, a geographic region associated with the organization, and a competitive position associated with the organization;
determine a set of improvements to the organization based on the weighted set of agility scores; and
prioritize the set of improvements based on a level of need of the set of improvements as indicated by the weighted set of agility scores.
